(19) United States
(12) Patent Application Publication
(10) Pub. No.: US 2006/0015282 A1
(43) Pub. Date: Jan. 19, 2006

(54) System and method for testing a display device

(75) Inventors: Kuan-Hong Hsieh, Tu-cheng (TW); Zhong-Wu Tian, Shenzhen (CN); Xin Lu, Shenzhen (CN); Jun-Jian Li, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/175,770

(22) Filed: Jul. 6, 2005

(30) Foreign Application Priority Data
Jul. 15, 2004 (CN) 200410028157.1

(51) Int. Cl. G06F 19/00

(52) U.S. Cl. 702/108

(57) ABSTRACT

A display device testing system includes a video signal outputting apparatus (10), a remote controller (20), a back board (30) and a display device (40). The video outputting apparatus outputs video signals which contain one or more testing samples provided for testing the display device to the display device. The remote controller generates control signals to control the display device to display the testing samples. The back board includes an interface. The interface receives the control signals from the controller, combines the control signals with the video signals into mixed signals, and transmits the mixed signals to the display device to obtain a test result. The test result is sent back to the remote controller via the back board for evaluating the performances of the display device. A related method is also disclosed.

### BACKGROUND OF THE INVENTION

1. Field of the Invention

The present invention relates to systems and methods for testing electronic products, and particularly to a system and method for testing display devices.

2. General Background

Display devices, such as Liquid Crystal Displays, Plasma Display Panels, etc., generally undergo a final testing process. For example, testing is done in order to determine whether the image quality of the display device is satisfactory for launching of the device into the market. The testing items of a display device typically include brightness, chrominance, contrast, etc. Each of these testing items needs to be carefully tested to evaluate the image quality.

A traditional testing process mainly requires an operator to manually manipulate setting buttons on a panel of a display device. The operator switches among testing items such as brightness, chrominance, and contrast, in order to determine one by one whether each of the items has met standard requirements. This manual testing process may be unduly time-consuming and waste valuable manpower, especially in the case of mass production of the display devices.

What is needed, therefore, is a system and method for testing display devices, which is capable of automatically testing the display devices in order to overcome the above-mentioned problems.

### SUMMARY OF THE INVENTION

To solve the above mentioned and other problems, a display device testing system (hereinafter “the system”) is provided. The system includes a video signal outputting apparatus, a remote controller, a back board and a display devices which needs to be tested. The video outputting apparatus outputs video signals to the display device. The video signals contain one or more testing samples provided for testing the display device. The remote controller generates control signals to control the display device to display the testing samples. The back board includes an interface, for example, the back board configured with a VGA ((video graphic array) interface or a DVI ((digital visual interface) interface. The interface receives the control signals from the controller, combines the control signals with video signals containing one or more testing samples into mixed signals, and transmits the mixed signals to the display device to obtain a test result. The control signals and the video signals are combined into mixed signals by means of pins of the interface. For example, the control signals and the video signals are combined via 12^{th} and 15^{th} pins of the VGA or via 6^{th} and 7^{th} pins of the DVI. The mixed signals are output to the display device so that the display device displays test samples and obtains the test result according to the mixed signals. The test result is sent back to the remote controller via the back board for evaluating the performances of the display device.

Further, a display device testing method is also provided. The method includes: (a) providing video signals containing one or more testing samples via a video signal outputting apparatus; (b) generating and transmitting control signals containing instructions to control the display device to display the testing samples in correspondence to one or more testing items preset by an operator; (c) receiving and combining the control signals with the video signals containing a testing sample to obtaining combined signals, wherein the control signals and the video signals are combined via pins of a video signal output interface; (d) transmitting the combined signals to the display device; (e) displaying the testing sample and obtaining a test result of the testing items; and (f) evaluating the test result of the display device.

Other advantages and novel features of the invention will become more apparent from the following detailed description when taken in conjunction with the accompanying drawings, in which:

### BRIEF DESCRIPTION OF THE DRAWINGS

FIG. 1 is a block diagram showing hardware infrastructure of a system for testing display devices according to a preferred embodiment of the invention; and

FIG. 2 is a flowchart showing a preferred method for testing a display device according to the present invention.

### DETAILED DESCRIPTION OF THE PREFERRED EMBODIMENTS

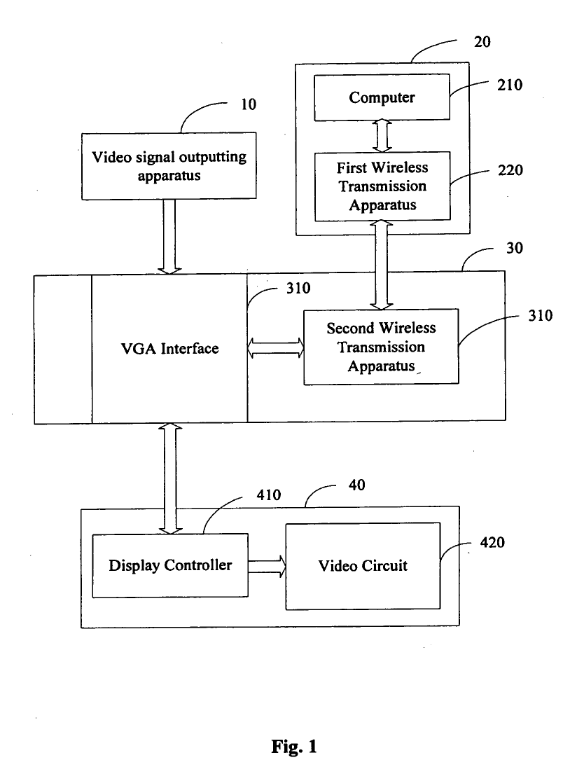

FIG. 1 is a block diagram of hardware infrastructure of a system for testing a display device 40 (hereinafter “the testing system”) according to a preferred embodiment of the present invention. The testing system mainly includes a video signal outputting apparatus 10, a remote controller 20, and a back board 30. The video outputting apparatus 10 is a computer or any other suitable apparatus, which is adapted for outputting video signals to the display device 40. The video signals contain one or more testing samples provided for testing the display device 40. The remote controller 20 preferably includes a computer 210 and a first wireless transmission apparatus 220. The computer 210 and the first wireless transmission apparatus 220 are interconnected with each other via a COM (Communication) port or an LTP (Print Port) port of the computer 210.

The computer 210 communicates with the display device 40 via the back board 30 and the first wireless transmission apparatus 220. The computer 210 is utilized to generate and transmit control signals. The control signals generally contain example instructions for controlling the display device to display given testing samples in correspondence to testing items set by an operator, and for displaying an analysis result to the operator. The computer 210 is also utilized to analyze obtained test result data of the display device 40. For example, once it receives the test result data from the back board 30, the computer 210 compares the test result data with standard reference data that are pre-stored in the computer 210. The computer 210 analyzes the test result data to generate an analysis result to determine whether the display device 40 is qualified, and then displays the test result data and the analysis result to the operator. For example, if the display device 40 fails to meet a standard requirement on a given testing item according to a corresponding analysis result, the computer 210 then displays the test result data and the analysis result to the operator.

The first wireless transmission apparatus 220 includes a transmitter and a receiver. The first wireless transmission apparatus 220 is interconnected with the back board 30 by a wireless connection. Wireless signals transmitted between the first wireless transmission apparatus 220 and the back board 30 can be in a form of infrared waves, microwaves, or ultrasonic waves. In another exemplary embodiment, the remote controller 20 may consist of only a first wireless transmission apparatus 220 to transmit or receive the wireless signals. In the absence of the computer 210, the first wireless transmission apparatus 220 further includes a built-in micro-programmed control unit (MCU) (not shown), a display unit (not shown), and a plurality of operational buttons (not shown). The MCU, the display unit and the operational buttons cooperatively allow an operator to preset testing items, and analyze obtained test result data. Likewise, once receiving the test result data from the back board 30, the MCU compares the test result data with standard reference data that are pre-stored in the MCU, analyzes the test result data to generate an analysis result in order to determine whether the display device 40 is qualified, and displays the test result data and the analysis result to the operator. For example, if the display device 40 fails to meet a standard requirement on a testing item according to a corresponding analysis result, the MCU then controls the display unit to display the test result data and the analysis result to the operator. In the preferred embodiment of the present invention, the remote controller 20 controls the testing of the display device 40 by way of the wireless signals transmitted between the first wireless transmission apparatus 220 and the back board 30.

The back board 30 is utilized to mix up the control signals from the remote controller 20 with the video signals from the video signal outputting apparatus 10, and to thereby generate mixed signals. The back board includes a VGA (video graphic array) interface 310 and a second wireless transmission apparatus 320. The second wireless transmission apparatus 320 is similar to the first wireless transmission apparatus 220. The first and second wireless transmission apparatuses 220, 320 intercommunicate with each other by the wireless connection.

The VGA interface 310 is generally a 15-pin VGA interface. The VGA interface 310 has a 12^{th} pin used as an SDA (serial data line) and a 15^{th} pin used as an SCL (serial clock line). By means of the 12^{th} and 15^{th} pins, the control signals and the video signals are combined with each other, and the mixed signals are obtained. The mixed signals containing the control signals and the video signals are then transmitted in a common VGA cable. In an alternative embodiment, a DVI (digital visual interface) interface may be employed as a substitute for the VGA interface 310. The DVI interface serves as a communication channel between the video outputting apparatus 10 and the display device 40. The control signals and the video signals are combined into mixed signals via 6^{th} and 7^{th} pins of the DVI interface. The mixed signals are then transmitted to the display device 40.

The display device 40 mainly includes a display controller 410 and a display circuit 420. The display controller 410 generally includes an MCU. The display controller 410 is used to control the display circuit 420 to display the testing samples and thereby obtaining the test result data on each testing item that is preset by the operator, as described above. The test result data are then sent back to the remote controller 20 via the back board 30, for evaluating the performance of the display device 40.

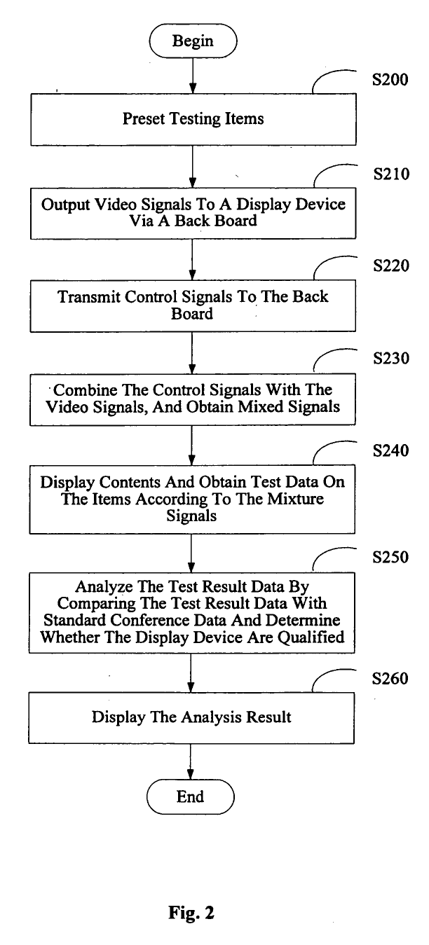

FIG. 2 is a flowchart of a preferred method for testing display devices according to the present invention. The method includes the following steps. In step S200, an operator presets testing items via the remote controller 20. In step S210, the video signal outputting apparatus 10 transmits video signals containing one or more testing samples to the display device 40 via an interface of the back board 30. In the illustrated embodiment, the interface can be a VGA interface 310 or a DVI interface that is configured in the back board 30. In step S220, the remote controller 20 transmits a control signal containing the testing items preset by the operator to the back board 30. In step S230, the back board 30 mixes up the control signal with the video signals via pins of the interface 310, generates a mixed signal accordingly, and then outputs the mixed signal to the display device 40. In step S240, the display device 40 displays the testing samples, and obtains the test result data on the testing items preset by the operator. The test result data are then transmitted back to the remote controller 20 via the back board 30. In step S250, the remote controller 20 analyzes the test result data by comparing the test result data with standard reference data to determine whether the display device 40 is qualified based on the analysis result. In step S260, the remote controller 20 displays the analysis result and the test result data to the operator.

Although the present invention has been specifically described on the basis of preferred embodiments and a preferred method, the invention is not to be construed as being limited thereto. Various changes and modifications may be made to the embodiments and method without departing from the scope and the spirit of the invention.

What is claimed is:

1. A system for testing a display device, comprising:
a controller for generating control signals to control the display device to display predetermined information; and
a back board comprising an interface for receiving the control signals from the controller, combining the control signals with video signals containing one or more testing samples into mixed signals, and transmitting the mixed signals to the display device to obtain a test result.

2. The display device testing system as claimed in claim 1, further comprising a video signal outputting apparatus for supplying the video signals to the display device via the back board.

3. The display device testing system as claimed in claim 1, wherein the control signals are wireless signals.

4. The display device testing system as claimed in claim 1, wherein the control signals generated by the controller contain instructions to control the display device to display testing samples in correspondence to testing items set by the controller.

5. The display device testing system as claimed in claim 1, wherein the control signals generated by the controller contain instructions to control the display device to obtain one or more test results.

6. The display device testing system as claimed in claim 5, wherein the controller is adapted for comparing the test result with a standard reference to generate an analysis result.

7. The display device testing system as claimed in claim 1, wherein the back board further comprises a transmission apparatus for communication with the controller.

8. The display device testing system as claimed in claim 1, wherein the interface is a video signal output interface.

9. The display device testing system as claimed in claim 8, wherein the control signals and the video signals are combined by means of pins of the video signal output interface.

10. The display device testing system as claimed in claim 9, wherein the video signal output interface is a VGA (video graphic array) interface or a DVI (digital visual interface) interface.

11. The display device testing system as claimed in claim 10, wherein the control signals and the video signals are combined via 12^{th} and 15^{th} pins of the VGA interface or via 6^{th} and 7^{th} pins of the DVI interface.

12. The display device testing system as claimed in claim 1, wherein the display device comprises a display controller for controlling display of the testing samples.

13. The display device testing system as claimed in claim 1, wherein the display device comprises a display circuit for displaying the testing samples contained in the video signals.

14. A method for testing a display device, comprising:
(a) providing video signals containing one or more testing samples via a video signal outputting apparatus;
(b) generating and transmitting control signals containing instructions to control the display device to display the testing samples in correspondence to one or more testing items preset by an operator;
(c) receiving and combining the control signals with the video signals containing a testing sample to obtaining combined signals;
(d) transmitting the combined signals to the display device;
(e) displaying the testing sample and obtaining a test result of the testing items; and
(f) evaluating the test result of the display device.

15. The display device testing method as claimed in claim 14, wherein in step (f) the test result is compared with a standard reference to obtain an analysis result.

16. The display device testing method as claimed in claim 15, wherein step (f) further comprises the step of determining whether the display device is qualified based on the analysis result.

17. The display device testing method as claimed in claim 14, wherein in step (c) the control signals and the video signals are combined via pins of a video signal output interface.

18. The display device testing method as claimed in claim 17, wherein the video signal output interface is a is a VGA (video graphic array) interface or a DVI (digital visual interface) interface.

19. The display device testing system as claimed in claim 18, wherein the control signals and the video signals are combined via 12^{th} and 15^{th} pins of the VGA interface or via 6^{th} and 7^{th} pins of the DVI interface.

20. A method for testing a display device, comprising:
presetting testing items for said display device via preparing related video signals transmissible to said display device;
generating control signals transmissible to said display device for controlling display of said display device according to each of said testing items;
mixedly transmitting said video signals and control signals to said display device; and
evaluating said display of said display device according to testing results from said display device for said each of said testing items.
